(19) United States
(12) Patent Application Publication
(10) Pub. No.: US 2009/0052172 A1
(43) Pub. Date: Feb. 26, 2009

(54) Bar light

(76) Inventor: Chen Keng Sheng, Taipei County (TW)

Correspondence Address: RABIN & Berdo, PC, 1101 14TH STREET, NW, SUITE 500, WASHINGTON, DC, 20005, US

(21) Appl. No.: 11/892,473

(22) Filed: Aug. 23, 2007

(51) Int. Cl. F21V 8/00; F21V 5/00; F21V 7/00

(52) U.S. Cl. 362/240

(57) ABSTRACT

A bar light is disclosed to include two light source holders, and a light transmissive light guide bar connected between the light source holders and aimed with its two ends at a respective light source in each light source holder and having light reflecting spots arranged over the periphery for reflecting light from the light sources in such a manner that the number of counts of the light reflecting spots is gradually increased in axial direction from the two opposite ends of the light transmissive light guide bar toward the middle part. In an alternate form, only one light source holder is provided at one end of the light guide bar, and the other end of the light guide bar is capped with an end cap and a reflector in the end cap.

### BACKGROUND OF THE INVENTION

1. Field of the Invention

The present invention relates to lighting fixtures and more particularly, to a bar light for illumination and decoration purposes.

2. Description of the Related Art

LEDs (Light Emitting Diodes) are intensively used for the purpose of illumination, signaling, or decoration, for the advantage of long working life and low power consumption. For example, the third stop lights of regular cars commonly use LEDs. The LEDs of a third stop light are arranged in a line. When the driver steps on the stop pedal, the LEDs of the third stoplight are driven to give off light. Further, LEDs are also intensively used for vehicle stoplights, directional lights, or internal decorative lights to substitute for conventional lamp bulbs. However, for illumination purpose, a single piece of LED does not provide sufficient intensity of light. Therefore, a LED lamp generally uses a number of LEDs. However, using a number of LEDs relatively increases the cost of the LED lamp. Moreover, light directly emitted from a LED is not soft.

Taiwan patent application no. 095211117, filed by the present inventor, discloses a lighting fixture designed to eliminate the aforesaid problem. According to this design, the lighting fixture comprises a single piece of LED or a limited number of LEDs, a light guide bar for guiding light from the LED(s), and reflectors bonded to a part of the periphery of the light guide bar and one end of the light guide bar opposite to the LED(s) to reflect light from the LED(s) out of the light guide bar through the outer surface of the light guide bar. According to this design, the reflectors are separately prepared and then bonded to the periphery and one end of the light guide bar. The installation of the reflectors greatly complicates the fabrication procedure, thereby increasing the cost. Further, the uniformity of reflected light from the reflectors is still not perfect.

### SUMMARY OF THE INVENTION

The present invention has been accomplished under the circumstances in view. It is therefore the main object of the present invention to provide a bar light, which eliminates the drawback of high cost of the conventional LED lamps that use a big number of LED chips. It is another object of the present invention to provide a bar light, which eliminates the drawback of sharp light of the conventional LED lamps. It is still another object of the present invention to provide a bar light, which eliminates the drawback of low uniformity of reflected light of Taiwan patent application no. 095211117.

According to one aspect of the present invention, the bar light uses one single LED or a limited number of LEDs to emit light into a light transmissive light guide bar from each end of the light transmissive light guide bar, enabling light to be reflected by light reflecting spots of the light transmissive light guide bar, providing a soft illumination. The light reflecting spots are arranged over the periphery of the light transmissive light guide bar in such a manner that the number of counts of the light reflecting spots is gradually increased in axial direction from the two opposite ends of the light transmissive light guide bar toward the middle part. Therefore, reflected light is uniform and soft.

According to another aspect of the present invention, a convex lens is provided between each end of the light transmission light guide bar and the associating light source to gather light from the associating light source and to guide gathered light toward the inside of the light transmissive light guide bar in axial direction for reflecting by the light reflecting spots of the light transmissive light guide bar.

According to still another aspect of the present invention, the use of the convex lenses is determined subject to the type of the LEDs of the light sources. In case flat LEDs are used, the convex lenses are necessary. In case bulb-like LEDs are used, the convex lenses can be omitted.

In an alternate form of the present invention, the light transmissive light guide bar has one end mounted with one light source holder and one light source in the light source holder, and the other end capped with an end cap and a reflector in the end cap.

According to still another aspect of the present invention, the light transmissive light guide bar has a rough outer surface for refracting light, softening the illumination.

According to still another aspect of the present invention, the light transmissive light guide bar can be made having a circular or polygonal cross section, or any other profile.

According to still another aspect of the present invention, the light transmissive light guide bar can be made having integrated raised portions over the periphery for reflecting light. Further, the light reflecting spots can be formed on the surface of the light transmissive light guide bar by printing.

According to still another aspect of the present invention, the bar light uses a light transmissive light guide bar to guides out light from a limited number of LEDs, providing a soft illumination and reducing the manufacturing cost.

### BRIEF DESCRIPTION OF THE DRAWINGS

FIG. 1 is an exploded plain view of a bar light in accordance with one embodiment of the present invention.

FIG. 2 is a schematic sectional assembly view of the bar light shown in FIG. 1.

FIG. 3 is a schematic sectional assembly view of a part of an alternate form of the bar light according to the present invention.

FIG. 4A is a schematic plain view in an enlarged scale of a part of the light guide bar according to the present invention.

FIG. 4B is a side plain view of FIG. 4A.

FIG. 5 is a schematic sectional assembly view of another alternate form of the bar light according to the present invention.

FIG. 6 is a cross sectional view of one form of the light guide bar for bar light according to the present invention.

FIG. 7 is a cross sectional view of another form of the light guide bar for bar light according to the present invention.

FIG. 8 is a cross sectional view showing a serrated pattern of the rough outer surface of the light guide bar for bar light according to the present invention.

### DETAILED DESCRIPTION OF THE PREFERRED EMBODIMENT

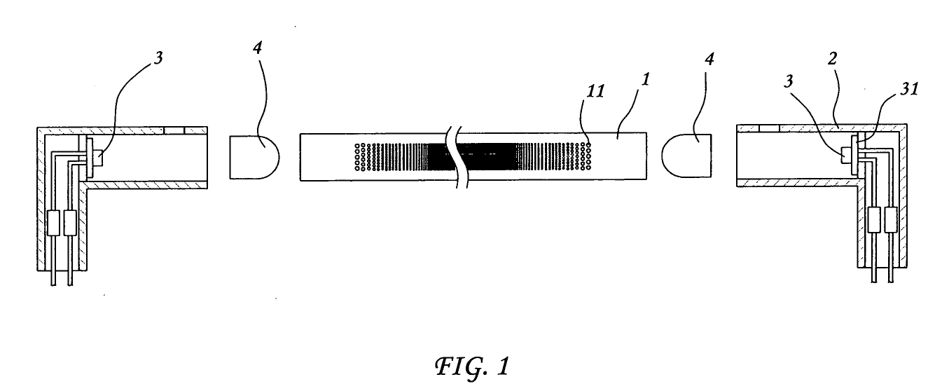

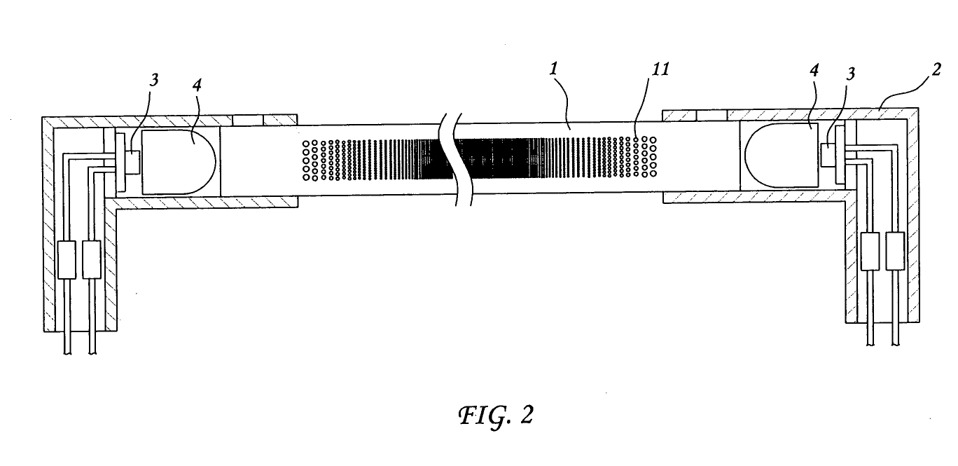

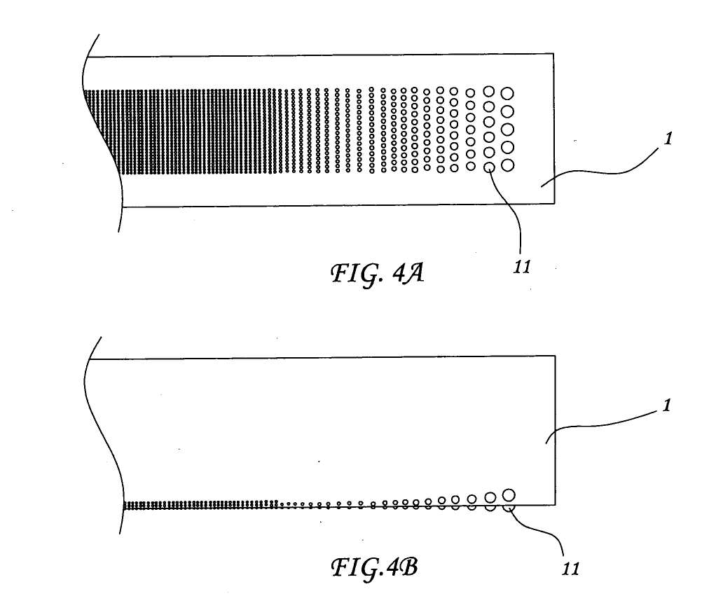

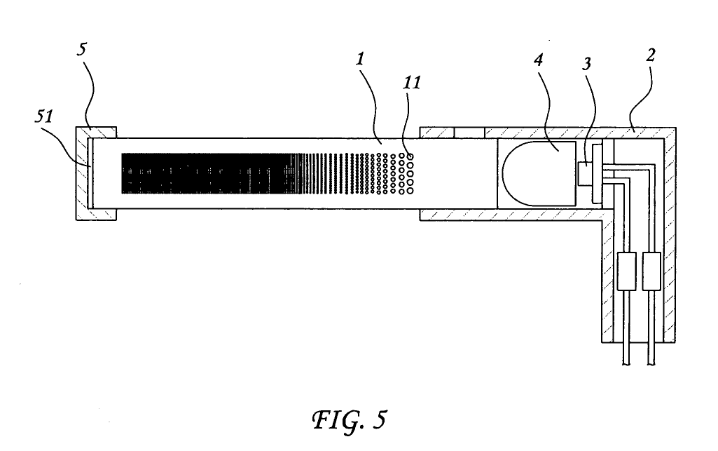

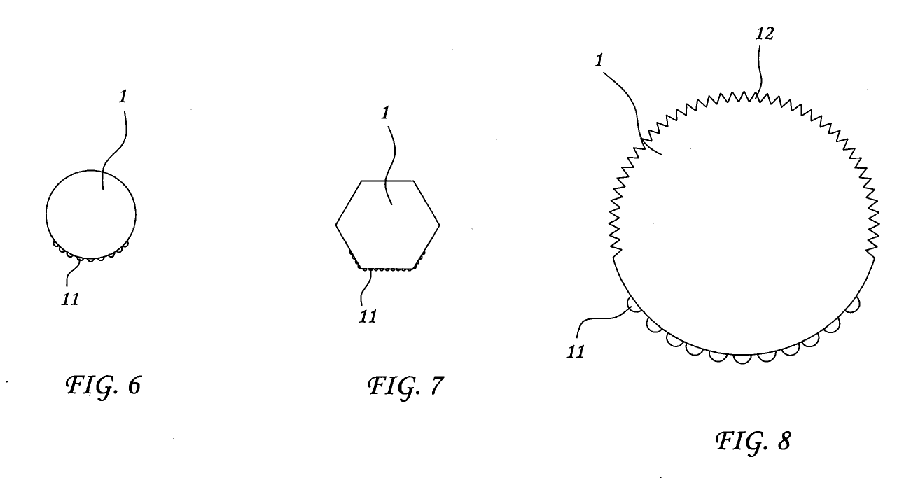

Referring to FIGS. 1 and 2, a bar light in accordance with one preferred embodiment of the present invention is shown comprised of a light guide bar 1, and two light sources 3 at the two distal ends of the light guide bar 1. The light guide bar 1 is an elongated bar of light transmissive chemical compound. The light guide bar 1 can be made having a circular cross section (see FIG. 6), hexagonal cross section (see FIG. 7), or any other polygonal or geometrical shape. Further, the light guide bar 1 can be made in the form of a rectilinear bar or arched bar, having a rough outer surface 12 that refracts light (see FIG. 8). The rough outer surface 12 can be comprised of multiple teeth showing a serrated pattern, raised portions, cones, etc. Further, the light guide bar 1 comprises a plurality of light reflecting spots 11 distributed over the rough outer surface 12 in such a manner that the number of counts of the light reflecting spots 11 is gradually increased in axial direction from the two distal ends toward the middle part (see FIGS. 4A and 4B). The light reflecting spots 11 can be formed in integrity with the light guide bar 1 during the fabrication. Alternatively, the light reflecting spots 11 can be printed on the outer surface of the light guide bar 1.

The bar light further comprises two light source holders 2 respectively fastened to the two distal ends of the light guide bar 1. The two light sources 3 are respectively mounted inside the light source holders 2, each having a circuit board 31. According to this embodiment, flat LEDs (light emitting diodes) are used for the light sources 3. Further, two convex lenses 4 are respectively mounted in between the two distal ends of the light guide bar 1 and the two light source holders 2, and adapted to gather light from the light sources 3 and to guide gathered light into the two distal ends of the light guide bar 1 in axial direction.

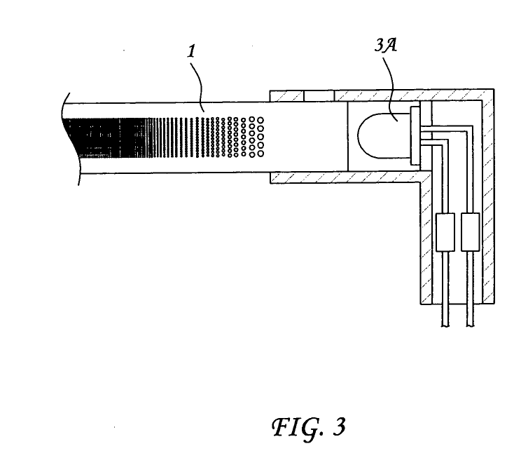

When light from the light sources 3 goes axially into the inside of the light guide bar 1 from its two distal ends, a part of the light passes directly out of the light guide bar 1 through the peripheral wall of the light guide bar 1, and a part of the light is reflected outwards by the light reflecting spots 11, thereby providing a soft illumination. Because the number of counts of the light reflecting spots 11 is gradually increased in axial direction from the two distal ends toward the middle part, the light reflecting spots 11, reflected light has even and soft characteristics. Further, when bulb-like LEDs are used for the light sources 3, the aforesaid convex lenses 4 can be omitted (see FIG. 3), allowing light from the light sources 3 to go into the inside of the light guide bar 1 directly.

FIG. 5 shows an alternate form of the present invention. According to this embodiment, only one light source holder 2 is fastened to one end of the light guide bar 1 to hold one light source 3 and one convex lens 4 on the inside, and the other end of the light guide bar 1 is capped with an end cap 5. The end cap 5 has a reflector 51 fixedly mounted on the inside and stopped at the corresponding end of the light guide bar 1 for reflecting light that goes from the light source 3 through the light guide bar 1. In case a bulb-like LED is used for the light source 3, the convex lens 4 can be omitted.

A prototype of bar light has been constructed with the features of FIGS. 1-8. The bar light functions smoothly to provide all of the features discussed earlier.

Although particular embodiments of the inventions have been described in detail for purposes of illustration, various modifications and enhancements may be made without departing from the spirit and scope of the invention. Accordingly, the invention is not to be limited except as by the appended claims.

What the invention claimed is:

1. A bar light comprising:
two light source holders;
two light sources respectively installed in said light source holders; and
a light transmissive light guide bar connected between said light source holders, said light transmissive light guide bar having two opposite ends respectively connected to said light source holders and respectively aimed at said light sources, and a plurality of light reflecting spots arranged over the periphery thereof for reflecting light from said light sources in such a manner that the number of counts of said light reflecting spots is gradually increased in axial direction from the two opposite ends of said light transmissive light guide bar toward a middle part of said light transmissive light guide bar.

2. The bar light as claimed in claim 1, further comprises two convex lenses respectively mounted in said light source holders between said light sources and said light transmissive light guide bar.

3. The bar light as claimed in claim 2, wherein said light guide sources each are comprised of at least one light emitting diode.

4. The bar light as claimed in claim 2, wherein said light transmissive light guide bar has a rough peripheral surface.

5. The bar light as claimed in claim 2, wherein said light transmissive light guide bar has a circular cross section.

6. The 1 bar light as claimed in claim 2, wherein said light transmissive light guide bar has a polygonal cross section.

7. The bar light as claimed in claim 2, wherein said wherein said light transmissive light guide bar is a rectilinear bar.

8. The bar light as claimed in claim 2, wherein said light guide bar is arched.
